(19) United States
(12) Patent Application Publication
(10) Pub. No.: US 2007/0165814 A1
(43) Pub. Date: Jul. 19, 2007

(54) Method and a system for providing ringback information

(75) Inventors: Caidong Wang, Chiba (JP); Masanori Goto, Chiba (JP); Tsuneyuki Sakano, Kanagawa (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/651,084

(22) Filed: Jan. 9, 2007

(30) Foreign Application Priority Data
Jan. 13, 2006 (JP) 2006-005973

(51) Int. Cl. H04M 3/42

(52) U.S. Cl. 379/201.01

(57) ABSTRACT

An information providing system includes a terminal on the side of a call originator, a terminal on the side of a call terminator, a content server, and an IP network. When the originator makes a call meant for the terminator, the one user terminal on side of the terminator transmits to the other user terminal on side of the originator information on contents to be provided to the latter so as to make the originator specify either contents or an audible ringing tone. As a result, if the originator specifies contents, the contents are provided from the content server to the one user terminal. Conversely, if the originator specifies a ringing tone, then a ringing tone is provided to the one user terminal in a known manner.

### BACKGROUND OF THE INVENTION

1. Field of the Invention

The present invention relates to a method and a system for providing a terminal of a call originator calling up a call terminator with ringback information which informs the originator that the terminator is being called up until the terminator answers the call. More particularly, the present invention relates to a method and a system for delivering various contents in the form of ringback information, which may include, e.g. pictures, videos, text, musical or audio data, and applications, alone or in combination.

2.Description of the Background Art

In general, when a call originator or calling party makes a call to a call terminator or called party, to the originating terminal is provided with ringback information which indicates that the terminator is being called up until the terminator answers the call. In the prior art, such information has been audible ringing tone, or a ringback tone produced by, e.g. the call-terminated telephone switch or any other intervening switch. Recently, there is a communication service for providing contents, instead of such a ringing tone, which include pictures, videos, text, musical or audio data and applications, etc. This communication service is sometimes referred to as “Coloring Ringback Tone (CRBT).”

Specifically, in the communication service, when an originator calls up a terminator who has joined the service and selected contents to be provided to an originator during calling, the contents are provided to the terminal of the originator instead of a ringing tone. The originator thus waits for the terminator to answer the call while watching, listening to or reading the contents played on the terminal of the originator. U.S. patent application publication No. 2002/0183048 A1, for example, discloses a method of providing music instead of a ringing tone to a terminal of an originator until a terminator answers the call. International publication No. WO 01/06735 A2 also discloses a method of providing voice, text, and images to a terminal of an originator instead of a ringing tone until a terminator answer the call. Furthermore, Japanese patent laid-open publication No. 2005143003 disclosed a method wherein a calling terminal may set a ringing tone audible to the calling terminal when calling a called terminal.

However, in the communication services, there has a problem that call originators are limitative to ones to which such services are available although there are a wide variety of terminal. For example, when a call originator, whose terminal cannot play sound, calls up a terminator who has selected a sound and still picture service to be provided to originating terminals instead of a ringing tone, he or she is obliged to receive an audible ringing tone until the terminator answers the call because the originating terminal cannot enjoy the service.

In addition, since contents selected by a terminator are played regardless of the situation or preferences of an originator, there has arisen a proble such that the contents are played even in the situration where the originator does not want them. Moreover, the played contents causes an originator to be incurred with a fee appropriate for the originator and undesired contents are played which make the originator unpleasant.

### SUMMARY OF THE INVENTION

It is an object of the present invention to provide a method and a system therefor capable of providing, when a call originator makes a call to a call terminator, ringback information to the terminal of the originator until a call is established, depending on functions of the originating terminal, or situation or preferences of the originator.

In a method and a system for providing ringback information according to the present invention, a terminal on the side of a call terminator includes a storage for storing information indicating contents which have been selected to be provided to the terminal of the originator instead of an audible ringing tone when a call is receibed, and a transmitter for transmitting the stored information to an originating terminal on the side of the call originator. Furthermore, the terminal on the side of the call originator includes a determiner for determining which ringback information the terminator has been selected, a ringing tone or contents. The determiner determines, in the case of contents, whether or not the content can be played on the terminal itself on the basis of the functions of the originating terminal and originator's situation. Therefore, when the originator makes a call to the terminator, it is possible to inform the originator what is ringback information. In addition, it is possible for the originator to specify either a ringing tone or contents as ringback information depending upon the functions of the originating terminal and originator's situation.

Therefore, for example, if the contents selected by the terminator cannot be played on the originating terminal, or if the originator does not desire to play the contents, then a ringing tone is provided to the originating terminal. Conversely, if the contents selected by the terminator can be played on the originating terminal and the originator desires to play the contents, then the contents are provided to the originating terminal.

In this way, the terminal of the terminator transmits the information indicating contents to the terminal of the originator, and the originator specifies either contents or ringing tone on the basis of this information, the functions of the originating terminal and the originator's situation. It is thus possible to provide the originator with suitable ringback information for the functions of the originating terminal and the situation or preferences of the originator. Note that information on contents may be transmitted from a mediate device, such as a communication server or telephone switch, which functions as mediating, or settling a connection on, communication between the terminals of the originator and the terminator. Moreover, the mediate device may specify either a ringing tone or contents as ringback information.

According to the present invention, either a ringing tone or contents are specified as ringback information on the basis of the functions of a terminal and/or the intentions of the originator. It is thus possible to provide suitable ringback information for the originating terminal and/or situation of the originator.

In the specification, the words “ringback information” are understood as directed to information or signals provided from telecommunications networks to a calling terminal device during a period in which a called terminal device is rung in the form of either, or a combination, of pictures, videos, text, musical or audio data, and applications as well as in the form of audible ringing tone.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of a system for providing ringback information in accordance with the present invention;

FIG. 2 is a schematic block diagram showing a terminal of a call originator included in the illustrative embodiment shown in FIG. 1;

FIG. 3 is a schematic block diagram showing a terminal of a call terminator included in the illustrative embodiment;

FIG. 4 is a sequence chart useful for understanding an exemplified operational procedure for providing a ringing tone or contents to the terminal of the originator in the illustrative embodiment;

FIG. 5 is a schematic block diagram showing the communication server included in the illustrative embodiment;

FIG. 6 shows the schematic configuration of exemplified information on contents stored in the storage of the communication server shown in FIG. 5;

FIG. 7 is a sequence chart, like FIG. 4, useful for understanding another exemplified operational procedure for providing a ringing tone or contents to the terminal of the originator in the illustrative embodiment shown in FIG. 1;

FIG. 8 is a schematic block diagram, like FIG. 5, showing an alternative communication server included in the illustrative embodiment shown in FIG. 1;

FIG. 9 exemplarily shows information on the function of terminals and the intention of originators which is stored in the determiner of the communication server shown in FIG. 8;

FIG. 10 is a sequence chart, like FIG. 4, useful for understanding an exemplified alternative operational procedure for providing a ringing tone or contents to the terminal of the originator in the illustrative embodiment;

FIG. 11 is a schematic block diagram showing an alternative preferred embodiment of a system for providing ringback information in accordance with the present invention;

FIG. 12 is a schematic block diagram showing the communication server included in the alternative embodiment shown in FIG. 11;

FIG. 13 is a sequence chart useful for understanding an exemplified alternative operational procedure for providing a ringing tone or contents to the terminal of the originator in the alternative embodiment;

FIG. 14 is a schematic block diagram showing the content server shown in FIGS. 1 and 11; and

FIG. 15 is a sequence chart useful for understanding an exemplified alternative operational procedure for providing a ringing tone or contents to the terminal of the originator in the illustrative embodiment shown in FIG. 1.

### DESCRIPTION OF THE PREFERRED EMBODIMENTS

Briefly, the system for providing ringback information in accordance with the invention provides, when a call originator, or calling party, makes a call to a call terminator, or called party, ringback information which informs the originator that the terminator is being called up until the terminator answers the call. The ringback information to be provided to the terminal of the originator is either in the form of ringing tone or contents which the terminator has selected in advance in order to service the originator instead of an audible ringing, or ringback, tone. The system of the invention determines in which form of ringback information is to be provided, a ringing tone or contents, depending on functions of the originating terminal, or situation or preferences of the originator so as to provide suitable ringback information to the terminal of the originator.

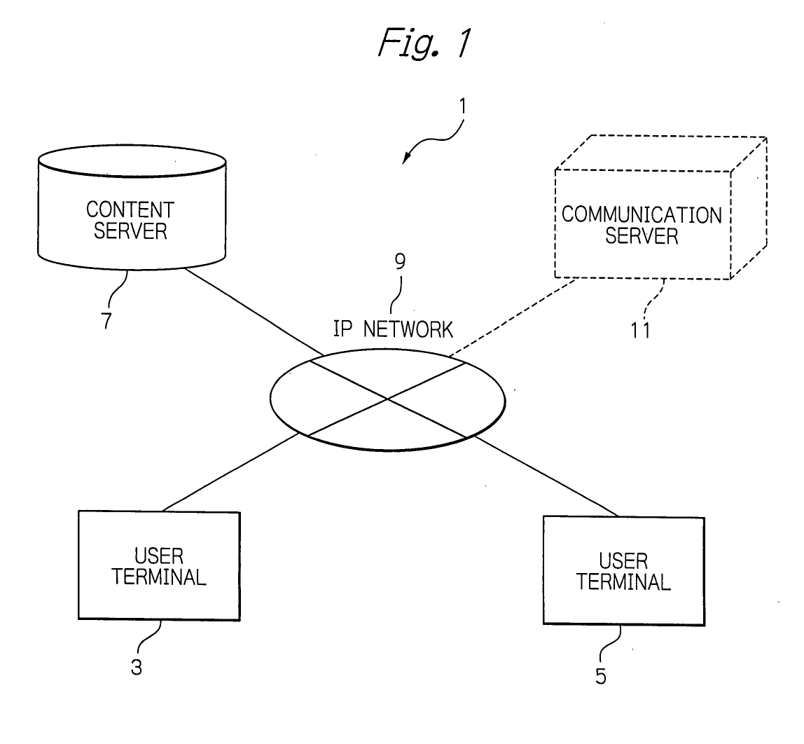

Referring to FIG. 1 of the accompanying drawings, an illustrative embodiment of the system 1 for providing ringback information in accordance with the invention includes user terminals 3 and 5, a content server 7, an Internet Protocol (IP) network 9 and communication server 11. In the figures, elements not directly relevant to the understanding of the present invention are not shown, and detailed description thereof will not be made in order to avoid redundancy. In the figure also, only two user terminals 3 and 5 are depicted, but in practice there are a lot of such terminals interconnected to the IP network 9.

The user terminals 3 and 5, content server 7, and communication server 11 are connected with the IP network 9 which transmits and receives signals under the Internet Protocol (IP). In the illustrative embodiment, the user terminal 3 is of an originator who makes a call whereas the user terminal 5 is of a terminator who takes the call, merely by way of example, thus establishing the communication under the Session Initiation Protocol (SIP) over the IP network 9. Note that the present invention is not limited to this specific embodiment, but may adopt, e.g. a public switched telephone network (PSTN) and use suitable protocol for the network.

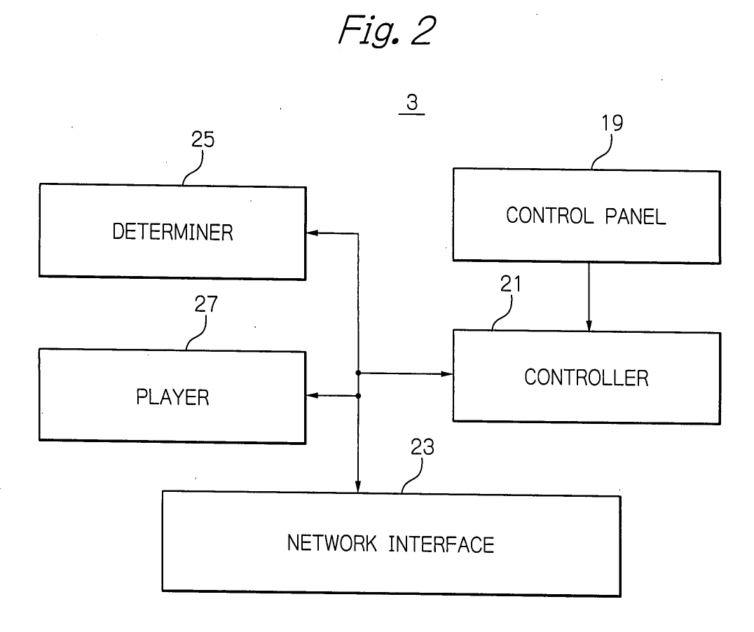

The user terminal 3, as shown in FIG. 2, includes a control panel 19, a controller 21, a network interface 23, a determiner 25, and a content player 27. The control panel 19 is a manipulatable device operated by the user for inputting desired commands. More specifically, the control panel 19 sends an operation signal to the controller 21 in response to the user's operation. The controller 21 is a general controller adapted to control the operation of the entire user terminal 3 in response to, e.g. the signal received from the network interface 23 or operation signal fed from the control panel 19. In the illustrative embodiment, the controller 21 connects to the network interface 23, determiner 25, and player 27 in order to control them.

The network interface 23 is adapted to transmit digital signals to the IP network 9, and receive digital signals in the form of, e.g. signal stream and contents stream. The network interface 23 is, if necessary, adapted to decode and convert received signals into appropriate signals for the determiner 25 and player 27 so as to output the received signals or decoded and converted signals to the determiner 25 and player 27. In the illustrative embodiment, the network interface 23 transmits digital signals assembled and generated in the user terminal 3 to, e.g. the terminal 5, the content server 7, and the communication server 11 over the IP network 9, and receives digital signals transmitted from, e.g. the user terminals 5, the content server 7, and the communication server 11 over the IP network 9.

The signal received in the network interface 23 indicates information about content selected by a terminator in advance in order to be provided instead of a ringing tone when an originator makes a call to the terminator. For example, in the illustrative embodiment, packets include the filename of the contents with extensions, e.g. “.txt” or predetermined symbols, letters or characters indicating the contents as the information on the contents in order to inform the originator 3 that which contents the terminator 5 has selected instead of a ringing tone.

Note that the term “information on contents” may be understood as covering any information so long as it includes at least contents. For example, it may indicate a storage location for informing where the contents are stored, that is, a uniform resource identifier (URI) or uniform resource locator (URL). Note that the present invention is not limited to these examples. The information on contents can be made by the user terminal 3 or communication server 11 to be transmitted, e.g. in the form of packets, to the user terminal 3 over the IP network 9 so as to be received by the network interface 23 of the user terminal 3. The network interface 23 then sends the received information on the contents to the determiner 25.

The determiner 25 is adapted to determine whether or not contents can be provided to the user terminal 3 so as to specify either contents or a ringing tone to be provided to the user terminal 3 as ringback information based on the information on the contents. Note that the determiner 25 can determinate with any other information on, e.g. the function of the user terminal 3 or time schedule, desires or intentions of the originator device 3. In the illustrative embodiment, the determiner 25 uses the information on the function of the user terminal 3 stored in, e.g. the determiner 25 or storage, not shown.

The player 27 includes a display panel, a display circuit and a sound-reproducing circuit, not shown, and has the function of visualizing the signal fed from the network interface 23 in the form of visual images.

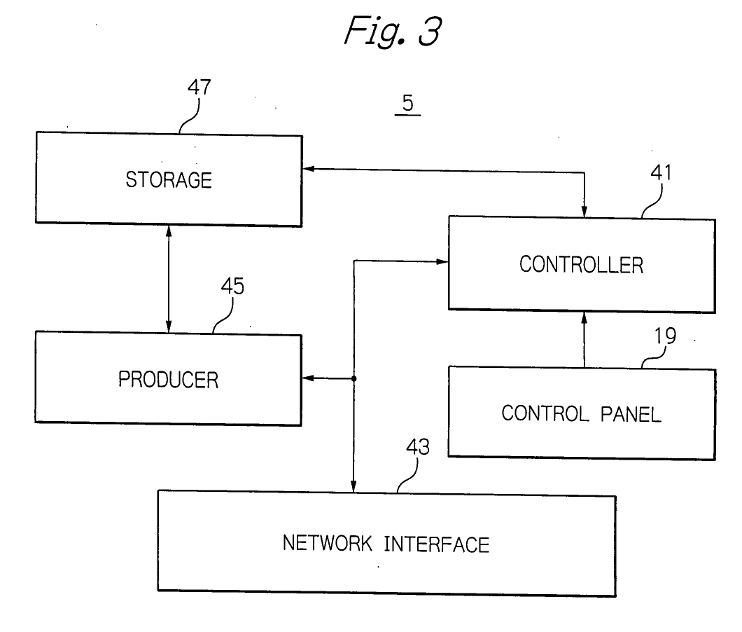

Referring again to FIG. 1, the user terminal 5 is an information terminal on the side of call terminator who receives a call. In the illustrative embodiment, the user terminal 5, as shown in FIG. 3, includes a control panel 39, a controller 41, a network interface 43, an information producer 45, and a storage 47. In FIG. 3, the control panel 39 and controller 41 are like the control panel 19 and controller 21 shown in FIG. 2, respectively, and will not be described specifically in order to avoid redundancy.

The information producer 45 is adapted to produce aforementioned information on contents under the control of the controller 5 when the network interface 43 receives a signal requesting the establishment of communication from the user terminal 3. The information produced by the producer 45 is transmitted to the user terminal 3 over the IP network 9 in the form of packets.

The storage 47 stores the information required for the producer 45 to produce information on contents, that is, information indicating contents that have been selected beforehand by a recipient. In the illustrative embodiment, the storage 47 stores the filename with extensions or symbols, letters, characters, etc., indicating the kinds of the contents.

Note that the storage 47 may store any other information on contents, e.g. an Internet address at which contents are stored, the file size of the contents. The storage 47 may also store data on conditions which allow the producer 45 to produce information on contents. Such conditions may include, e.g. the number or identification of the user terminal 3 able to be provided with contents instead of a ringing tonal signal, and a time zone of the day at which contents can be provided if the user terminal 3 is one which has been specified by the terminator as a user terminal to which contents can be provided and a time zone at which contents are allowed to be provided.

The configuration of the user terminals 3 and 5 described above are similarly applicable to a known device which can make a call, e.g. mobile/cellar telephone terminal set, a personal digital assistant (PDA) or a terminal with an IP telephone function. Of course, the individual structural parts and elements of the user terminals 3 and 5 are only illustrative and may be changed or modified, as desired. For example, the producer 5 of the user terminal 5 may be formed by installing a program sequence for producing information on contents when the terminator subscribes to the service for providing contents rather than a ringing tone.

The user terminals 3 and 5 also may be a broadband terminal directly connected to the IP network 9 or be provided with a device for connecting to the IP network 9 such as a gateway device. In this case, the network interface may be provided on the gateway device.

Referring again to FIG. 1, the content server 7 provides the function of storing plural contents, receiving delivery request information and delivering the contents corresponding the delivery request information. The content server 7 is installed on the center facility of a communication service provider providing contents instead of a ringing tone and managed by the provider, for example. The contents may be pictures, videos, text, musical or audio data, and applications, etc., which to be provided instead of a ringing tone.

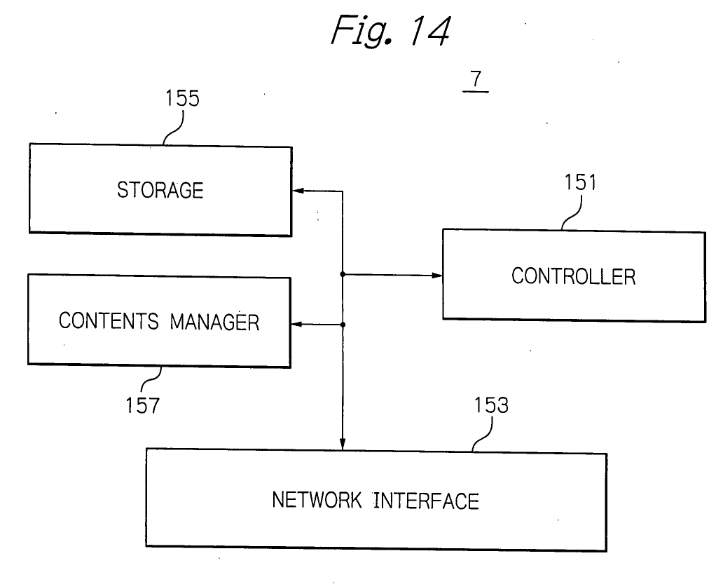

The content server 7 includes a storage 155, shown in FIG. 14, for storing contents, and a contents manager 157 for deciding whether or not to provide service to the user who requests to deliver the content to the terminal sending out a signal requesting the establishment of communication with the user. The content server also has a controller 151 for controlling the operation of the entire content server 7, and a network interface 153 for connecting to the IP network 9 so as to receive a signal requesting contents and transmit the contents stream.

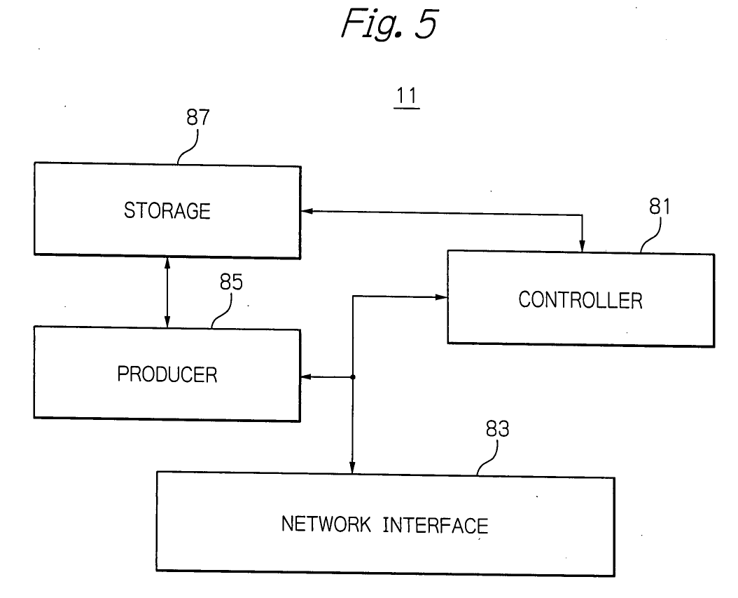

Referring again to FIG. 1, the communication server 11 is a device for mediating communication between the user terminals 3 and 5. In the illustrative embodiment, the communication server 11 is a SIP proxy server, and has a controller 81, shown in FIG.5, for controlling the operation of the entire communication server 11, and a network interface 83 for connecting to the IP network 9 so as to transmit and receive signals to and from the user terminals 3 and 5 over the IP network 9 to establish communication between the user terminals 3 and 5. In FIG. 1, the communication server 11 is shown by a dashed line on the ground that, when the user terminals 3 and 5 establish communication directly, e.g. on a peer-to-peer connection, they do not use the communication server 11. Note that when the communication server 11 is used for establishing communication, it may not necessarily be provided in a single unit nor in a single type, but in an arbitrary number and an arbitrary number of types in the system 1.

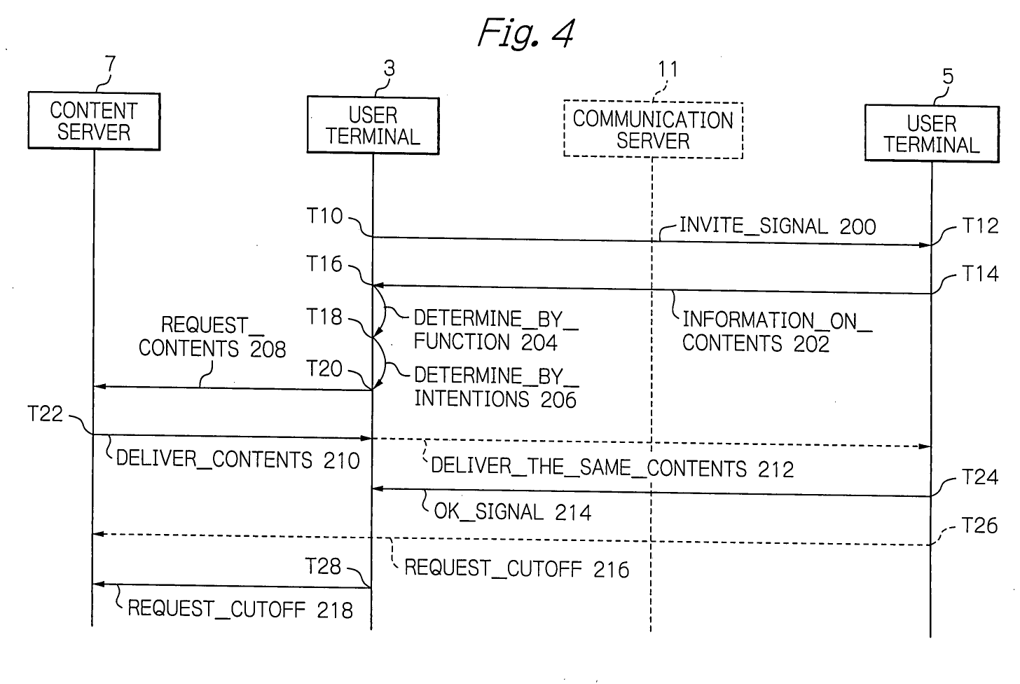

FIG. 4 is a sequence chart useful for understanding an exemplified operation procedure for providing a ringing tone or contents as ringback information to the user terminal 3, in the system 1 shown in FIG. 1. In FIG. 4, the communication server 11 is indicated by a dashed line on the ground that when the user terminals 3 and 5 are going to establish communication directly, the communication server 11 has no signal received or transmitted.

In FIG. 4, the user terminal 3 transmits an INVITE signal requesting an establishment of communication to the user terminal 5 at time T10 (INVITE_SHIGNAL 200). This INVITE signal is transmitted to the user terminal 5 and then received by the network interface 43 of the user terminal 5. When the network interface 43 receives the INVITE signal, the controller 41 renders the producer 45 produce information on contents which are selected by the terminator in advance to be provided to the user terminal 3 as ringback information. Note that if the terminator sets limits for an originator and a time zone of the day where the communication service can be provided, the controller 41 may determine whether or not the user terminal 3 or the time is adequate to provide contents before rendering the producer 45 produce such information depending on the determination.

In response to a command from the controller 41, the producer 45 produces information on contents to be provided to the user terminal 3 with reference to the storage 47. In the illustrative embodiment, since the contents are musical or audio data and pictures, the information on contents is two filenames with extensions. This information is then transmitted from the network interface 43 to the user terminal 3 at time T14 together with the ringback information for informing the originator that the terminator 5 is being called up (INFORMATION_ON_CONTENTS 202). When the ringback information is received by the network interface 23 of the user terminal 3, the information on contents is sent to the determiner 25. The determiner 25 then grasps the contents to be provided instead of a ringing tone so as to specify either a ringing tone or contents as playable information.

More specifically, the determiner 25 grasps the file type recognized from the extensions included in the information and checks the grasped file type against the functions of the user terminal 3 so as to determine whether or not the grasped contents can be played in the user terminal 3 at time T16 (DETERMINE_BY_FUNCTION 204). In the illustrative embodiment, since the contents are musical or audio data and pictures, the determiner 25 determines whether or not both musical or audio data and pictures are playable, or whether or not either one of them is playable, or whether or not neither is playable.

As a result of the determination at time T16, if the user terminal 3 can play both musical or audio data and pictures or either of them, then the determiner 25 further determines whether or not the originator desires to play the contents, at time T18 (DETERMINE_BY_INTENTIONS 206). More specifically, in the illustrative embodiment, the determiner 25 makes the display of the player 27 display words “Do you want to play?” on the display panel or a lamp, not shown, turned on so as to prompt an originator to input either “Yes” or “No.”

Of course, the procedure of the determiner 25 is only illustrative and may be changed or modified, as desired. For example, the determiner 25 or the storage may store the originator's desires or intentions, such that the terminator name or time zone that originator allows playing the contents, so as to use the stored originator's desires or intentions in the procedure of the determiner 25 as well as the functions of the user terminal 3. Moreover, the determiner 25 may determinate by either the functions of the originating device 3 or the intentions of an originator.

As a result of the determinations at times T16 and T18, if the user terminal 3 cannot play the contents, or if the originator does not desire to play the contents, then the determiner 25 specifies a ringing tone, which will be in turn provided to the user terminal 3 by processing known by itself. In the illustrative embodiment, the ringing tone is generated by the communication server 11 or any other site, such as the user terminal 5, so as to be listened to on the user terminal 3. Of course, this procedure is only illustrative and may be changed or modified, as desired.

On the other hand, as a result of the determination at time T18, if the originator 3 desires to play the contents, then the network interface 23 sends a signal requesting the contents specified by the determiner 25 to the content server 7 under the control of the controller 5 at time T20 in order to establish connection to the content server 7 (REQUET_CINTENTS 208). Specifically, if the determiner 25 specifies all of the contents, i.e. both musical or audio data and pictures, selected beforehand by the terminator, then the controller 21 requests both of them from the content server 7. Conversely, if the determiner 25 specifies part of the contents, i.e. either musical or audio data and pictures, then the controller 21 requests either musical or audio data and pictures, which is specified, from the content server 7. The signal requesting the contents can be formed with Hyper Text Transfer Protocol (HTTP) or SIP.

In response to the request signal from the user terminal 3, the content server 7 provides contents to the user terminal 3 at time T22 (DELIVER_INTENTS 210). As shown by a dashed line 212 in FIG. 4, the content server 7 may provide the same contents to the user terminal 5 at substantially the same timing as the timing at which the contents are provided to the user terminal 3 (DELIVER_THE_SAME_CONTENTS 212) so that the terminator can know how long the originator watches/listens the pictures/music or audio and answer the call without causing errors in the timing.

The contents provided from the content server 7 are received by the network interface 23. The network interface 23 then decodes and converts the contents into signals appropriate for playing. The same thing can be said for the user terminal 5 when the same contents are provided to the user terminal 5. The originator 3 waits for communication to be established, while watching or listening to contents being played. The terminator answers the call at arbitrary timing at time T24 (OK_SIGNAL 214), thereby establishing communication. When communication is established, the user terminal 3 requests for the cutoff of the communication with the content server 7 at time T28 (REQUEST_CUTOFF 216), and has the player 27 stop the playing of the contents. If the content server 7 has also provided contents to the user terminal 5, as shown by the dashed line 216, then the user terminal 5 also requests the cutoff of the communication with the content server 7 at time T26 (REQUEST_CUTOFF 218), whereby the communication with the content server is cut off.

As described above, contents or a ringing tone is provided to the user terminal 3 depending upon the functions of the user terminal 3 and/or intentions of the originator. It is thus possible to provide suitable ringback information to the originator for the functions of the originating terminal and/or situation or preferences of the originator.

Of course, the procedure of FIG. 4 is only illustrative and may be changed or modified, as desired. For example, the determiner 25 may be provided in at least either the communication server 11 or user terminal 3; and the storage 47 and producer 45 may also be provided in the communication server 11.

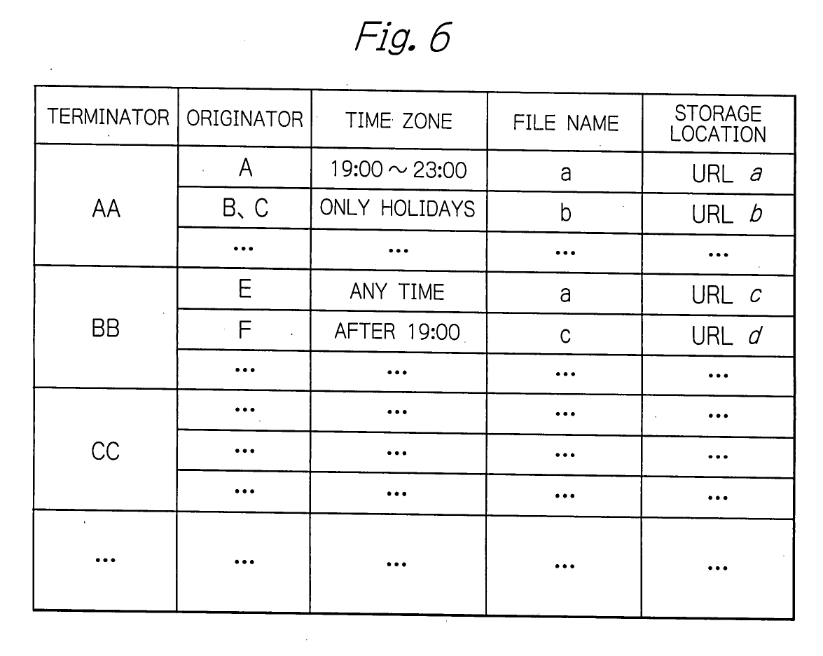

FIG. 5 is a schematic block diagram showing the communication server 11 shown in FIG. 1. FIG. 6 shows the schematic configuration of exemplified information on contents stored in the storage of the communication server shown in FIG. 5. In FIG. 5, the communication server 11 has an information producer 85 and a storage 87 as well as the controller 81 and network interface 83, which are adapted for being able to produce information on contents. Therefore, in the illustrative embodiment, even in an application in which the user terminal 5, shown in FIG. 1, does not contain the producer 45 and storage 47, information on contents can be produced by the communication server 11 so as to be transmitted to the user terminal 3, and the determiner 25 of the user terminal 3 can select either a ringing tone or contents depending upon the functions of the user terminal 3 and intentions of the originator.

In FIG. 5, the producer 85, like the producer 45 in the user terminal 5 shown in FIG. 3, is adapted to produce information on contents under the control of the controller 5 when the network interface 83 receives a signal requesting the establishment of communication from the user terminal 3.

The storage 87, like the storage 47 shown in FIG. 3, stores the information required for the producer 85 to produce the information on contents, that is, information indicating contents that have been selected to be provided to the originator instead of a ringing tone by the terminator in advance. Note that the storage 87 shown in FIG. 5 stores information selected by a plurality of terminators while the storage 47 shown in FIG. 3 stores only information on contents selected by the terminator who uses the user terminal 5.

More specifically, the storage 87 stores information on contents of a plurality of terminators who establish communication with the communication server 11 since the storage 87, FIG. 5, is provided in the communication server 11. In the illustrative embodiment, the storage 87 stores filenames and time zone for each of the terminators and further originators. For example, with respect to a terminator AA shown in FIG. 6, the storage 87 stores individual time zone and filename of the originators A, B, C, . . . , who are defined to be provided with contents in stead of a ringing tone by a terminator AA in advance. Note that the present invention is not limited to this example.

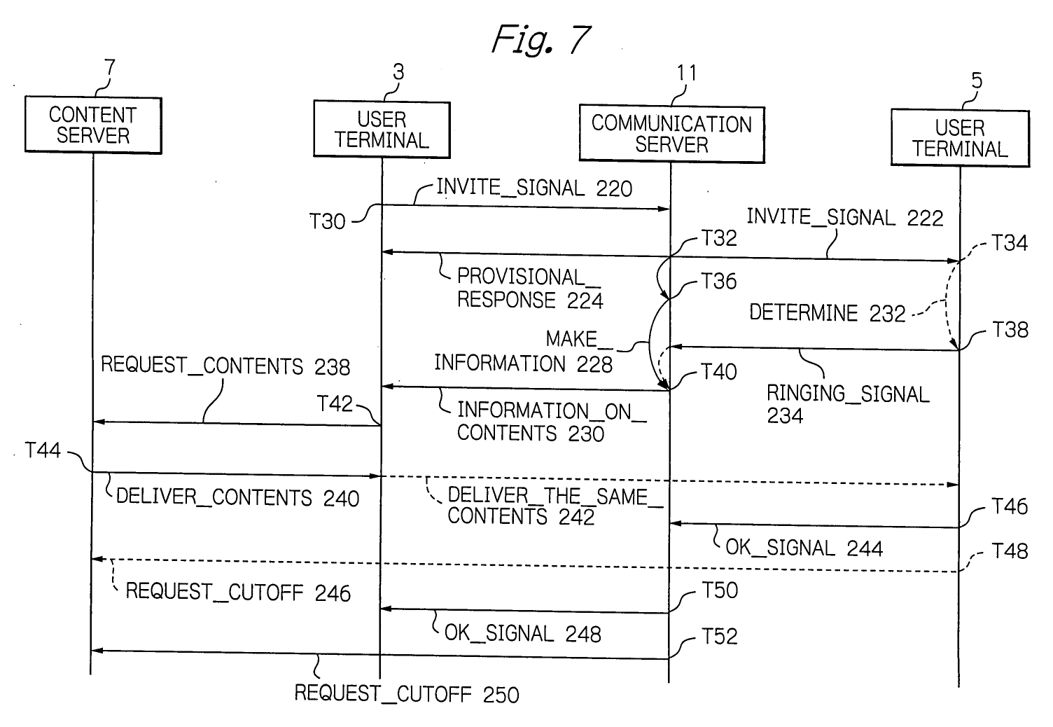

FIG. 7 is a sequence chart useful for understanding another exemplified operational procedure for providing a ringing tone or contents to the user terminal 3, in the information providing system 1 shown in FIG. 1. In the example shown in FIG. 7, the procedure is like what is shown in FIG. 4 except that the user terminals 3 and 5 establish communication with each other through the communication server 11 and that the communication server 11 produces information on contents.

In FIG. 7, the user terminal 3 transmits an INVITE signal to the communication server 11 at time T30 (INVITE_SIGNAL 220). This signal is received in the network interface 83, FIG. 5, of the communication server 11. The communication server 11 then sends the INVITE signal to the user terminal 5 at time T32 (INVITE_SIGNAL 222) in order to inform the user terminal 5 that there is a request for the establishment of communication from the user terminal 3. The communication server 11 also sends back a provisional response to the user terminal 3 (PROVISIONAL_RESPONSE 224).

Thereafter, the communication server 11 determines whether or not the user terminal 5 is a subscriber for the communication service which provides contents to the originator instead of a ringing tone at time T36 (DETERMINATION). As a result of the determination, if the user terminal 5 is a subscriber for the communication service, then the communication server 11 further determines other conditions such as a time zone stored in the storage 87, if necessary.

As a result of these determinations at time T36, if the user terminal 5 is not a subscriber for the communication service, or if the time is not a time zone to provide contents, then the communication server 11 executes process for providing a ringing tone to the user terminal 3 by means known by themselves. On the other hand, if the user terminal 5 is a subscriber for the communication service, and the time is included in a time zone to provide contents, then the communication server 11 executes the same processing as the producer 45, FIG. 3, to render the producer 85 producing the information on contents (MAKE_INFORMATION 228). The information on contents produced by the producer 85 is transmitted from the network interface 83 to the user terminal 3 at time T40 (INFORMATION_ON_CONTENTS 230).

At the same time, the user terminal 5 transmits to the communication server 11 a ringing signal indicating that the process of calling up the user terminal 5 itself is started, at time T38 (RINGIN SHIGNAL 234). Note that, as shown by a dashed line 232 in FIG. 7, if the terminator 5 has the producer 45 and storage 47 shown in FIG. 3, the information on contents may be produced by the producer 45 of the terminator 5 and then be transmitted to the communication server 11. More specifically, if the terminator 5 has the producer 45 and storage 47 shown in FIG. 3, the terminator 5 may receive the INVITE signal from the communication server 11 at time T34, and thereafter determine whether or not to produce the information on contents after (DETERMINE 232) to then produce the information on contents with the producer 45 and storage 47 so as to transmit the information to the communication server with the ringing signal. In this case, the communication server 11 may also send the information produced by both the user terminal 5 and the communication server 11 to the user terminal 3 at time T40, or either of them selected by, e.g. the communication server 11. Alternatively, the communication server 11 may overwrite the information produced by itself with the information made by the terminator 5 (SELECT OR_OVERWRITE 236). Note that the present invention is not limited to these examples.

The information on contents is then received by the network interface 23 of the user terminal 3 so that the determiner 25 checks the contents indicated by this information with the functions of the user terminal 3 and determines which part of the contents is playable and further whether or not the originator desires to play the part determined to be playable. As a result of the determination, if the user terminal 3 cannot play the contents, or if the originator does not desire to play the contents, then a ringing tone is provided to the user terminal 3 in a manner which may be known by itself.

On the other hand, if the user terminal 3 can play the contents and the originator desires to play the contents, then the user terminal 3 sends to the content server 7 a signal requesting the contents specified by the determiner 25 at time T42 (REQUEST_CONTENT 238). In response to the request signal, the content server 7 provides the contents to the user terminal 3 at time T44 (DELIVER_CONTENTS 240). When the contents are provided from the content server 7, the user terminal 3 receives the contents by the network interface 23 and plays them on the player 27 so that the originator 3 waits for the terminator 5 to take a call while watching or listening to the contents being played. As shown by a dashed line 242 in FIG. 7, the content server 7 may also provide the same contents to the user terminal 5 at substantially the same timing as the timing at which the contents are sent to the user terminal 3 (DELIVER_THE_SAME_CONTENTS 242).

Thereafter, the terminator sends a response signal to the communication server 11 at arbitrary timing, for example, at time T46 (OK_SIGNAL 244). As indicated by a dashed line 246 in FIG. 7, if the contents also have been provided from the content server 7, the user terminal 5 also sends a signal requesting the cutoff of the communication with the content server 7 at time T48 (REQUEST_CUTOFF 246). When the communication server 11 receives the response signal, the communication server 11 sends the response signal to the user terminal 3 in order to establish communication between the user terminal 3 and the user terminal 5 at time T50 (OK_SIGNAL 248), and also sends to the content server 7 a signal requesting the cutoff of the communication between the content server 7 and the user terminal 3 at time T52 (REQUEST_CUTOFF 250), whereby the communication between the content server 7 and the user terminal is cut off and the communication between the user terminal 3 and the user terminal 5 being established.

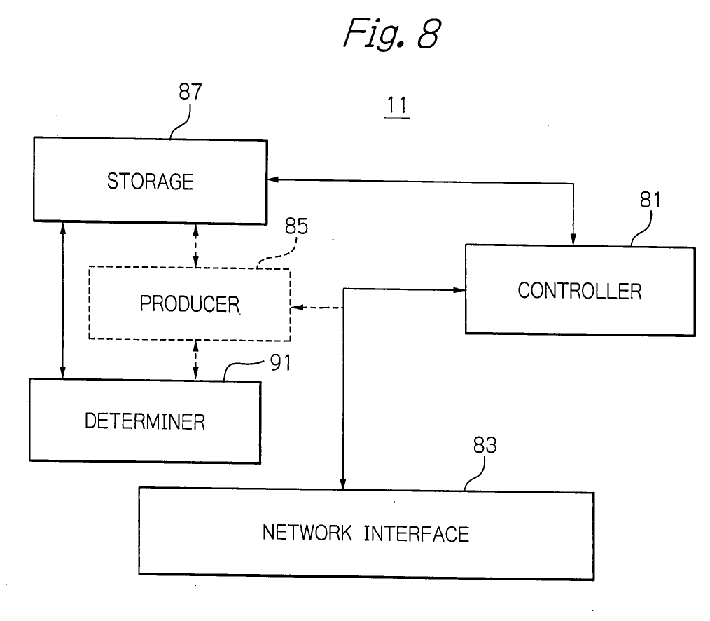

As described above, in the illustrative embodiment, since the communication server 11 includes the producer 85 and storage 87, it is therefore possible to provide either contents or a ringing tone depending upon the functions of the user terminal 3 and intentions of the originator even if the user terminal 5 does not include the producer 45 and storage 47. Note that the communication server 11 may further include a determiner 91 as well as the producer 85 and storage 87 as shown in FIG. 8.

FIG. 8 is a schematic block diagram, like FIG. 5, showing an alternative communication server in the system 1 shown in FIG. 1. In FIG. 8, structural parts and elements like those shown in FIG. 5 are designated by identical reference numerals, and will not be described specifically again in order to avoid redundancy. In FIG. 8, the communication server 11 further includes a determiner 91 as well as the controller 81, network interface 83 and storage 87. Note in FIG. 8 that the producer 85 is shown by a dashed line. The reason therefor is that, when the communication server 11 is provided with the determiner 91, the determiner 91 can specify contents to be provided to the user terminal by directly referencing information on contents stored in the storage 87, and therefore if at least the storage 87 and determiner 91 exist, the producer 85 does not need to exist. Note that even if the determiner 91 specifies contents by directly referencing information on contents stored in the storage 87, the communication server 11 may also include the producer 85.

In the alternative embodiment shown in FIG. 8, since the communication server 11 includes the storage 87 and determiner 91, it is possible to provide either a ringing tone or contents to the originating device 3 depending upon the functions of the originating device 3 and intentions of the originator even if the user terminals 3 and 5 do not include the determiner 25, producer 45 and storage 47. Note that, in the example shown in FIG. 8, the storage 87 and determiner 91 are provided in one communication server 11 because of making explanation easier. The present invention is, however, not limited to this example, but may adopt arbitrary configuration according to the system 1.

For example, the system 1 for providing ringback information may include two communication servers, a first communication server which communicates with the user terminal 3 and a second communication server which communicates with the user terminal 5. In this case, the determiner 91 may be provided in the first communication server, while the producer 85 and storage 87 may be provided in the second communication server. Note that the present invention is not limited to this example.

In FIG. 8, the determiner 91, as with the determiner 25 shown in FIG. 2, is adapted to determinate whether or not contents selected by the terminator can be provided to the user terminal 3 so as to specify either a ringing tone or contents to be provided to the user terminal 3 as ringback information under the control of the controller 81. The determiner 91, in FIG. 8, grasps contents by directly referencing the storage 87 in determination in contrast to the determiner 25, FIG. 2, which grasps contents from the received information on contents. In addition, the determiner 91 stores functions and originator's intentions of each of the user terminals that establish communication through this communication server 11, whilst the determiner 25, FIG. 2, stores the functions and originator's intentions of the user terminal 3 only.

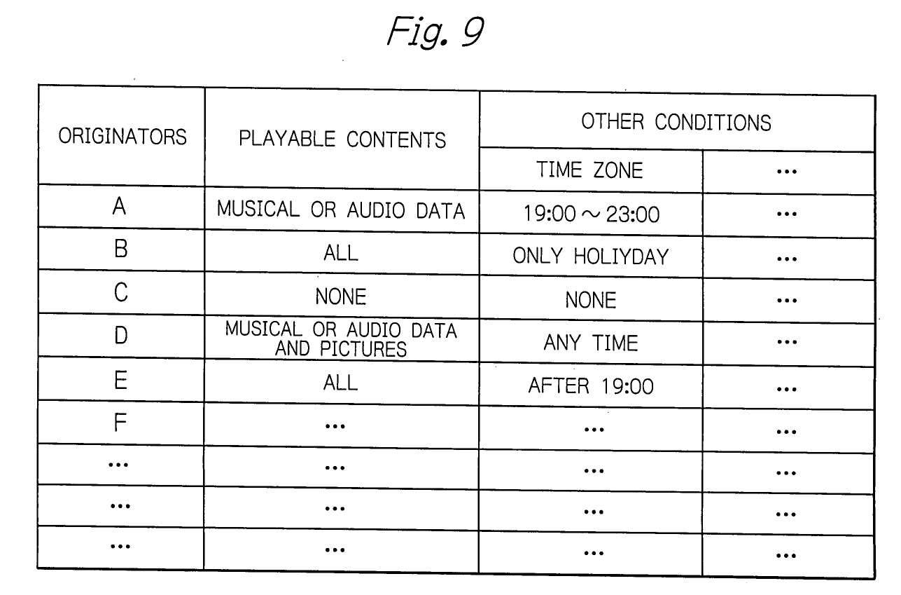

Specifically, in the alternative embodiment, since the communication server 11 has the determiner 91, it stores, e.g. the functions of the user terminals, a playable condition and other conditions for each of the user terminals, as shown in FIG. 9. For instance, in respect of a user terminal A, FIG. 9, the determiner 91 stores the playable file type of contents, such as musical or audio data, and the time zone, such as 19:00 to 23:00. Similarly, for user terminals B, C, . . . , playable contents, time zones, and other conditions are stored. The stored functions of the user terminals, etc., are, of course, only illustrative and may be changed or modified, as desired. For example, the determiner 91 may store average functions of all of the user terminals which establish communication through the communication server 11 in order to use in determination.

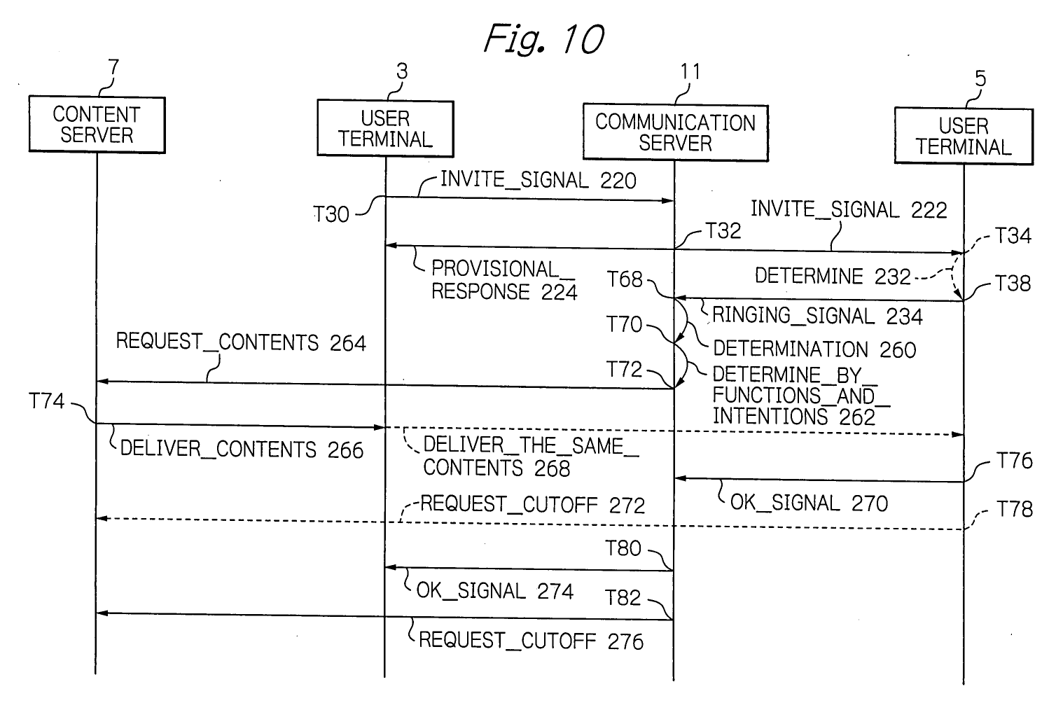

FIG. 10 is a sequence chart, like FIGS. 4 and 7, useful for understanding another exemplified operational procedure for providing a ringing tone or contents to the user terminal 3 as ringback information when a signal requesting the establishment of communication is sent from the user terminal 3 to the user terminal 5, in the system 1 shown in FIG. 1. In FIG. 10, the processes like those shown in FIG. 7 are designated by identical reference numerals and will not be described specifically again in order to avoid redundancy. The procedure shown in FIG. 10 is like that shown in FIGS. 4 and 7 except for the communication server 11 choosing either a ringing tone or contents.

In FIG. 10, the user terminal 3 transmits an INVITE signal to the communication server 11 at time T30 (INVITE_SIGNAL 220). This signal is received in the communication server 11. When the communication server 11 receives the INVITE signal from the user terminal 3, it sends the INVITE signal to the user terminal 5 at time T32 (INVITE_SIGNAL 222) for thereby informing the user terminal 5 that there is a request for establishing communication from the user terminal 3. The communication server 11 also sends back a provisional response signal to the user terminal 3 (PROVISIONAL_RESPONSE 224).

The INVITE signal is received by the network interface 43 of the user terminal 5. After the reception of the INVITE signal, the user terminal 5 transmits to the communication server 11 a ringing signal indicating that the process of calling up the user terminal 5 itself is started, at time T38 (RINGING_SIGNAL 234). At this time, as indicated by a dashed line in FIG. 10, the user terminal 5 may determine whether or not information on contents is produced at time T34, and then produce the information on contents so as to transmit the information on contents as well as the ringing signal if the user terminal 5 includes the producer 45 and storage 47 as shown in FIG. 3.

In the communication server 11, after the transmission of the INVITE signal and provisional response signal to the user terminals 5 and 3 respectively at time 32, the controller 81 of the communication server 11 determines whether or not the terminator of the user terminal 5 is a subscriber for the communication service with referencing the storage 87, and further determines, if any, the other conditions such as a time-zone at time T68 (DETERMINATION 260). Note that if information on contents is sent from the user terminal 5 at time T38, this determination may be made in accordance with this information. As a result of the determination, if the terminator 5 is not a subscriber or the time is not included in a time zone to provide contents, then the communication server 11 executes process for providing a ringing tone to the user terminal 3 by means known per se.

On the other hand, if the terminator 5 is a subscriber and the time is a time zone to be able to provide contents, then the determiner 91 grasps contents to be provided to the user terminal 3 instead of a ringing tone so as to determine whether or not the contents can be provided to the user terminal 3 at time T70 (DETERMINE_BY_FUNCTIONS_AND_INTENTIONS 262). In the determination, the determiner 91 may grasp contents from whichever information on contents the user terminal 5 has transmitted or the producer 85 produces. Moreover, the determiner 91 may grasp contents by directly referencing the storage 87.

In the alternative embodiment, the determiner 91 grasps contents by directly referencing the storage 87 so as to determine which part of the contents is playable, on the basis of the functions of the user terminal 3 and originator's intentions stored in the determination 9 beforehand. As a result of the determination, if the user terminal 3 cannot play the contents, then a ringing tone is provided to the user terminal 3 in such a manner which itself was known.

On the other hand, if the user terminal 3 can play part or all of the contents selected by the terminator, then the communication server 11 transmits a signal requesting the establishment of communication to the content server 7 at time T72 (REQUEST_CONTENTS 264) so that the content server 7 provides the part or all of the contents to the user terminal 3 at time T74 (DELIVER_CONTENTS 266). When contents are provided from the content server 7, the user terminal 3 receives the contents by the network interface 23 and has the player 27 playing them so that the originator waits for the terminator to take a call while watching or listening to the contents being played.

As shown by a dashed line 268 in FIG. 10, the content server 7 may also provide the same contents to the user terminal 5 at substantially the same timing (DELIVER_THE_SAME_CONTENTS 268). Thereafter, the user terminal 5 sends to the communication server 11 a signal indicating that the terminator answers the call, at arbitrary timing, for example, at time T76 (OK_SIGNAL 270). In addition, if the same contents have been provided from the content server 7, then the user terminal 5 sends a signal requesting the cutoff of the communication with the content server 7 at time T78 as shown by a dashed line, whereby the communication with the content server 7 is cut off (REQUSET_CUTOFF 272).

When the communication server 11 receives from the user terminal 5 the signal indicating that the terminator responds to a call, the communication server 11 sends the signal indicating that the call request is achieved to the user terminal 3 at time T80 (OK_SIGNAL 274) and sends a signal requesting the cutoff of the communication with the content server 7 at time T82 (REQUEST_CUTOFF 276), thereby cutting off the communication with the content server 7 so that the player 27 stops the playing of the contents so as to establish the communication with the user terminal 5.

As stated above, by including the producer 85, storage 87 and determiner 91 in the communication server 11, it is possible to provide either a ringing tone or contents depending upon the functions of the user terminal 3 and originator's intentions even if the user terminals 3 and 5 do not include the determiner 25, producer 45 and storage 47. Of course, the configuration of the communication server 11 shown in FIGS. 5 and 8 and also the procedure of FIG. 10 are only illustrative, and may be changed or modified as desired. For example, the communication server 11 may include only the determiner 91. Even if the communication server 11 includes only the determiner 91, such procedure as shown in FIG. 7 is carried out. Note that if the communication server 11 includes only the determiner 91, the user terminal 5 has to include the producer 45 and storage 47.

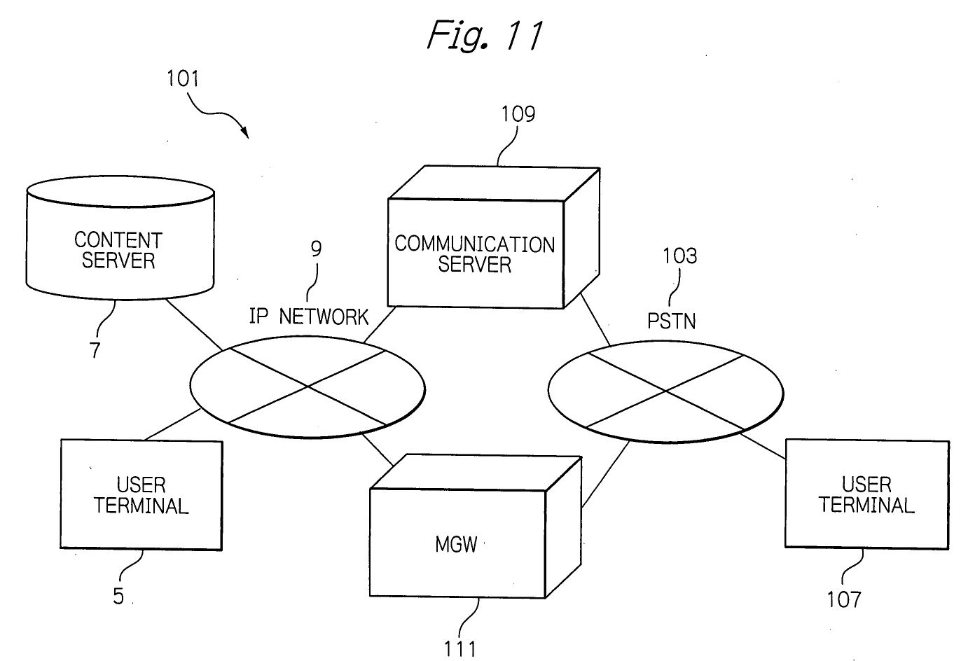

FIG. 11 is a schematic block diagram showing an alternative preferred embodiment of a system for providing ringback information in accordance with the present invention. In FIG. 11, structural parts and elements like those shown in FIG. 1 are designated by identical reference numerals, and will not be described specifically again in order to avoid redundancy. In a system 101 for providing ringback information shown in FIG. 11, there are two networks, an IP network 9 and a public switched telephone network (PSTN) 103. The IP network 9 has the user terminal 5 and content server 7 connected while the PSTN network 103 has the user terminal 107 and a telephone switch, not shown, connected. The user terminal 107 is of an originator who makes a call, the user terminal 5 is of a terminator who takes the call, in this example. It is to be noted that the present invention is not limited to this specific embodiment. For example, the user terminal 5 may connect with the PSTN network 103, whereas the user terminal 107 may connect with the IP network 9.

In FIG. 11, the user terminal 107 is, like the user terminal 3 shown in FIG. 1, a call originating terminal on the side of an originator who makes a call, by way of example. While the user terminal 3 shown in FIG. 1 connects with the IP network 9, the user terminal 107 shown in FIG. 11 connects with the PSTN network 103 through the switch, not shown, and communicates with the user terminal 5 connected to the IP network 9, through the communication server 109. In the alternative embodiment, since the communication server 109 specifies either a ringing tone or contents, the user terminal 107 includes no determiner. To the user terminal 107, applicable is any known type of device which can make a call.

The communication server 109 is connected with both the IP network 9 and the PSTN network 103, and adapted to mediate the establishment of communication between a terminal connected to the IP network 9 and a terminal connected to the PSTN network 103 for thereby establishing of the communication between the user terminal 107 and the user terminal 5, and providing contents from the content server 7 to the user terminal 107. In the alternative embodiment, the communication server 109 mediates the communication between the user terminal 5 connected to the IP network 9 and the user terminal 107 connected to the PSTN network 103, employing a call control protocol for controlling a call, such as No. 7 Signaling System ISUP (ISDN User Part). The communication server 109 also controls a media gateway (MGW) 111, which connects with both the IP network 9 and the PSTN network 103.

The media gateway 111 is adapted to convert a signal in the form used in the IP network 9 to a signal in a form usable in the PSTN network 103, or convert a signal in the form used in the PSTN network 103 to a signal in a form usable in the IP network 9 under the control of the communication server 109. For example, the media gateway 111 converts a voice signal used in the IP network 9 to a time-multiplexed signal. Note that to the media gateway 111 applicable is a device known by itself. In the alternative embodiment, while the communication server 109 and the media gateway 111 are formed separately, both the communication server 109 and the media gateway 111 may be incorporated into one device, for example.

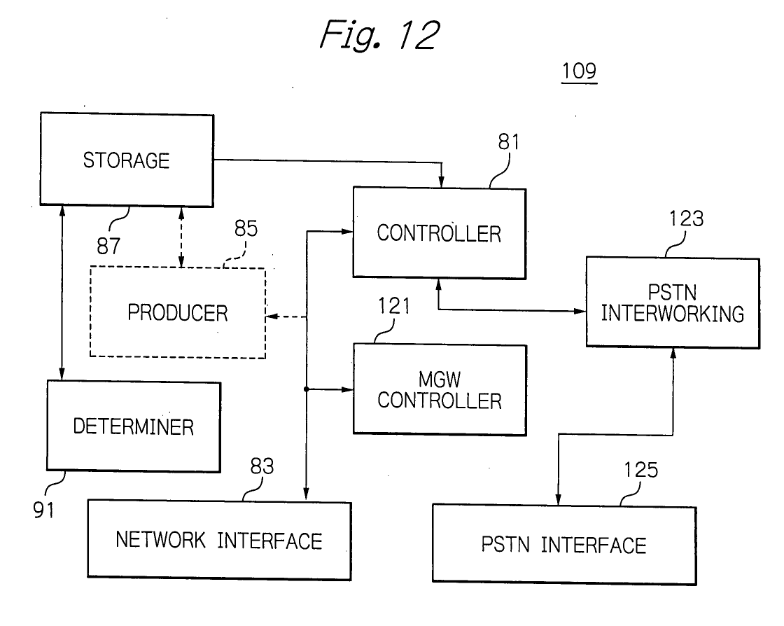

FIG. 12 is a schematic block diagram showing a communication server 109 included in the alternative embodiment shown in FIG. 11. In FIG. 12, structural parts and elements like those shown in FIGS. 5 and 8 are designated by identical reference numerals, and will not be described specifically again in order to avoid redundancy. In FIG. 12, the communication server 109 includes, an MGW controller 121, PSTN interworking 123 and PSTN signal network interface 125 as well as the controller 81, network interface 83, storage 87 and determiner 91. Note that the producer 85 may be omitted.

In the communication server 109 shown in FIG. 12, the controller 81 communicates with terminals connected to the IP network 9 by employing the Session Initiation Protocol (SIP) to perform the establishment and cut off of communication through the network interface 83. On the other hand, as to terminals connected to the PSTN network 103, the controller 81 controls calls by employing the ISUP (ISDN User Part) of the SS7 (Common Channel Signaling System No. 7), for example, for thereby establishing communication between terminals connected to the IP network 9 and terminals connected to the PSTN network 103.

In FIG. 12, the PSTN signal network interface 125 is a message transfer part of Signaling System No. 7, and adapted to transmit and receive signals to and from the PSTN network 103 so as to connect with the PSTN network 103. The signals received by the PSTN signal network interface 125 are fed to the PSTN interworking 123, which functions as converting the received signal to a signal which is to be transmitted to the IP network 9 and functions as converting a signal received from the IP network 9 to a signal which is to be transmitted to the PSTN network 103, for thereby controlling a ringing signal.

The MGW controller 121 is adapted to control the media gateway 111 shown in FIG. 11 employing a protocol for controlling the functions of the media gateway 111, e.g. MGCP (Media Gateway Control Protocol) or MEGACO (MEdia GAteway COntrol protocol). Of course, the configuration of communication server 109 shown in FIG. 12 is only illustrative and may be changed or modified, as desired.

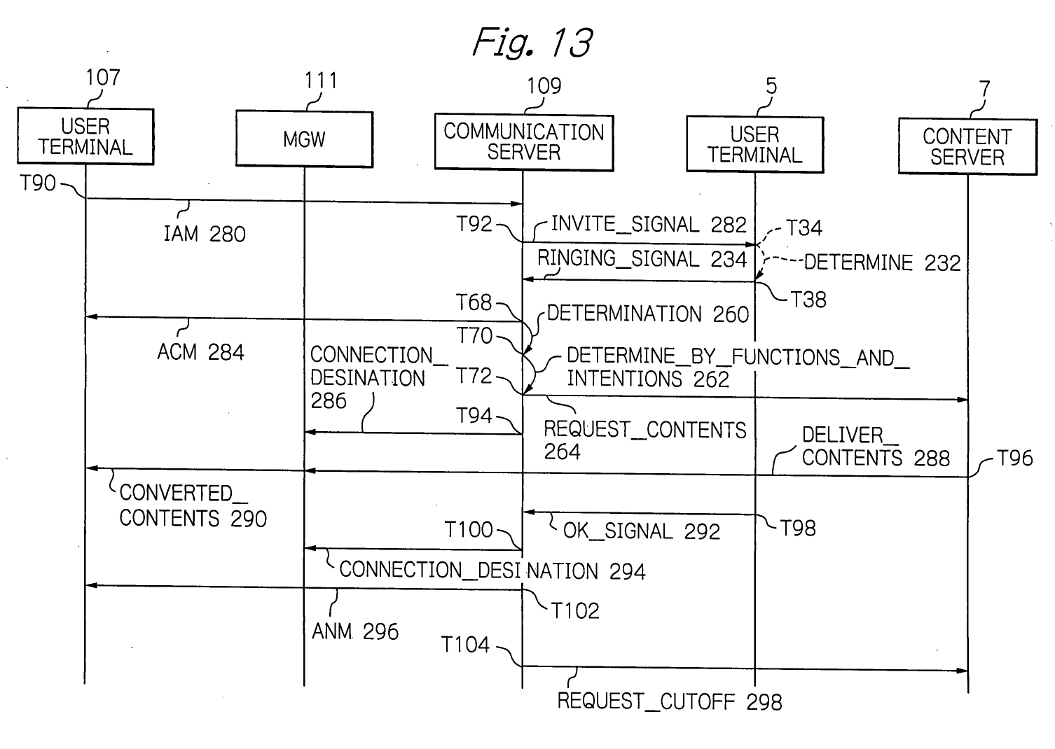

FIG. 13 is a sequence chart useful for understanding another exemplified operational procedure for providing a ringing tone or contents to the user terminal 107 as a ringnack information for informing a call originator that the terminator is being called up, until communication is established when a signal requesting the establishment of communication is sent from the user terminal 107 to the user terminal 5, in the information providing system 101 shown in FIG. 11. In FIG. 13, the processes like those shown in FIGS. 7 and 10 are designated by the identical reference numerals and will not be described repetitively in order to avoid redundancy. In the alternative embodiment shown in FIG. 13, the procedure for providing either a ringing tone or contents to the user terminal 107 depending upon the functions of the user terminal 107 and originator's intentions is like that shown in FIG. 10 except that signals for controlling a call are transmitted and received between the two networks, the IP network 9 and PSTN network 103.

In FIG. 13, the user terminal 107 transmits an initial address message (IAM) to the user terminal 5 through a telephone switch, not shown, in order to request establishing a connection with the user terminal 5 at time T90 (IAM 280). The initial address message may contain a known type of information, for example, information on a user terminal 5 requested to establish communication by the originator 107. The initial address message is transmitted over the PSTN network 103 so as to be received by the communication server 109. When the communication server 109 receives the initial address message, it transmits an INVITE signal to this user terminal 5 at time T92 (INVITE_SIGNAL 282), thereby informing the user terminal 5 that there occurs a request for a call from the user terminal 107. When the user terminal 5 receives the INVITE signal, it transmits to the communication server 109 a ringing signal at time T38 (RINGING_SIGNAL 234). At this time, if the user terminal 5 includes the producer 45 and storage 47 as shown in FIG. 3, the user terminal 5 may execute the same process of T34 shown in FIG. 7.

When the communication server 109 receives the ringing signal transmitted from the user terminal 5, it then sends an address complete message (ACM) to the user terminal 107 (ACM 284) and executes the same processes performed at the timing T68 and T70 shown in FIG. 10, i.e. determines whether or not the contents can be provided to the user terminal 3.

As a result of determining, if the terminator 5 is not a subscriber or the time is not in a time zone specified to provide contents, or the user terminal 3 cannot play the contents, then the communication server 11 executes process for providing a ringing tone to the user terminal 3 by means known per se. On the other hand, if the terminator 5 is a subscriber, the time is of a time zone to provide contents and the user terminal 3 can play part or all of the contents selected by the terminator, then the communication server 109 transmits to the content server 7 a signal requesting the establishment of communication at time T72 (REQUEST_CONTENTS 264). In the signal requesting the establishment of communication with the contents server 7, an address of the media gateway 111, such as the IP address or port number, is contained because the content delivered from the contents server 7 is need to be converted by the media gateway 111 in order to be provided to the user terminal 3.

The communication server 109 then gives instructions to the media gateway 111 to establish communication with the content server 7 and to convert contents delivered from the content server 7 to a signal in a form transmittable in the PSTN network 103, at time T94 (CONNECTION_DESINATION 286).

In response to the signal from the communication server 109, the content server 7 delivers the requested contents to the media gateway 111 at time T96 (DELIVER_CONTENTS 288), which are received in the media gateway 111 so as to be converted to a signal in a form transmittable in the PSTN network 103 and transmitted to the user terminal 107 (CONVERTED_CONTENTS 290). The user terminal 107 plays the contents sent from the media gateway 111 by the player, and the originator waits for the terminator to take a call while watching or listening to the contents. Note that the content server 7 may provide the same contents to the user terminal 5 at substantially the same timing as the timing at which the contents are provided to the user terminal 107.

When the terminator responds to a call, the user terminal 5 sends to the communication server 109 the signal indicating that the call request is achieved, at time T98 (OK_SIGNAL 292), so that the communication server 109 gives instructions to the media gateway 111 to establish communication with the user terminal 5 and also to convert the voice signal from the user terminal 107 to a voice signal in the IP network 9 and the reverse is also, at time T100 (CONNECTION_DESINATION 294). The communication server 109 also transmits to the user terminal 107 through the media gateway 111 an answer message (ANM) indicating that there is a response, at time T102 (ANM 296).

Therefore, the communication between the user terminal 5; and the media gateway 111 and the user terminal 107 are established whereby the communication between the user terminal 107 and the user terminal 5 is established. When communication between the user terminal 107 and the user terminal 5 is established, the communication server 109 sends to the content server 7 a signal requesting the cutoff the communication between the content server 7 and the media gateway 111 at time T104 (REQUEST_CUTOFF 298).

As stated above, by including the determiner 91 and storage 87 in the communication server 109, it is possible to provided either a ringing tone or contents depending upon the functions of the user terminal 107 and situation of the originator even if there are two networks using different signal, such as IP network 9 and PSTN network 103.

It should be noted that the present invention is not limited to the second embodiment. The configuration of the storage, producer, and determiner can be arbitrarily determined depending upon the communication server 109, user terminal 5, and user terminals 3, 107. For example, the information storages 47 and 87 and producers 45 and 85 may be provided in at least either the communication server 109 or the user terminal 5, and the determiners 25 and 91 may be disposed in at least either the communication server 109, the user terminals 3 and 107, or the telephone switch, not shown, of a central office.

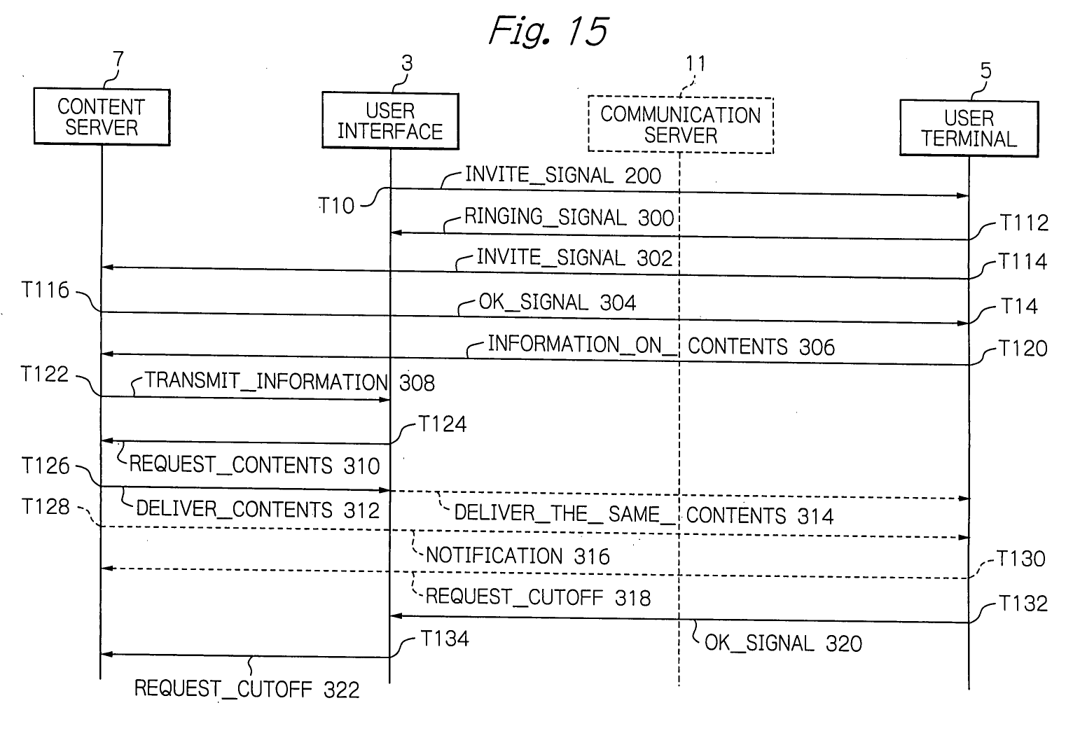

FIG. 15 is a sequence chart showing another exemplified operational procedure for providing a ringing tone or contents to the terminal of the originator in the illustrative embodiment shown in FIG. 1. In FIG. 15, the processes like those shown in FIG. 10 are designated by the identical reference numerals and will not be described specifically again in order to avoid redundancy. The procedure shown in FIG. 15 is the same as the procedure shown in FIG. 4, except that the content server 7 have the contents manager deciding whether or not the terminator of the user terminal 5 is subscribed for the communication service and deciding whether or not to provide the service to the originator who requests to deliver a content. In the alternative embodiment, since the content server 7 is connected to the IP network 9, the contents manager 157 authenticates the user terminal 5 using an authentication process of the SIP protocol so as to decide whether or not contents are provided to the user terminal 3.

In FIG. 15, the user terminal 3 sends an INVITE signal to the user terminal 5 at time T10 (INVITE_SIGNAL 200). When the user terminal 5 receives this signal, it transmits to the user terminal 3 a signal indicating that the user terminal itself is being called up, at time T112 (RINGING_SIGNAL 300). The user terminal 5 also sends an INVITE signal in order to request establishing communication with the content server 7 at time T114 (INVITE_SIGNAL 302). At this time, the contents manager 157 determines whether or not the terminator 5 is subscriber with, e.g. authentication of the SIP protocol.

As a result of the authentication, if the user terminal 5 is a subscriber, then the content server 7 transmits to the user terminal 5 an OK signal indicating that effect at time T116 (OK_SIGNAL 304) so that the user terminal 5 executes the same process as that of timing T14 shown in FIG. 4 for determining whether or not to produce information on contents. Conversely, if the user terminal 5 is not a subscriber, then the content server 7 transmits a signal for informing the user terminal 5 that the INVITE signal is unauthorized or transmits no signal, not shown. In such cases, the user terminal 5 may connect to another content server so as to be authenticated again, or decide to provide a ringing tone to the user terminal 3, for example.

As a result of the determination at time T14, if the information on contents is produced, then the user terminal 5 sends to the content server 7 the information at time T120 (INFORMTION_ON_CONTENTS 306), thereby requesting the content server 7 to transfer this information to the user terminal 3. That is, in this alternative embodiment, established is a call between the user terminal 3 and the content server 7 at the start, and thereafter, the call is transferred from the content server 7 to the user terminal 3. Note that the present invention is not limited to this example. For example, after receiving the OK signal, the user terminal 5 may cut off the communication with the content server 7 so as to establish the communication with the user terminal 3 to send the information on contents.

In response to the request from the user terminal 5, the content server 7 transmits an INVITE signal to the user terminal 3 at time T122 (TRANSMIT_INFORMATION 308), thereby transferring information on contents to the user terminal 3. The user terminal 3 receives this information by the network interface 23 and then executes the same processes as those of timing T16 and T18 shown in FIG. 4, i.e. the user terminal 3 has the determiner 25 deciding which part of the contents is playable and determining whether or not the originator desires to play the contents with received information.

As a result of the determination, if the user terminal 3 cannot play contents, or if the originator does not desire to play the contents, then the user terminal 3 is provided to a ringing tone in a manner known by itself. On the other hand, if user terminal 3 can play the contents and the originator desires to play the contents, the user terminal 3 sends to the content server 7 a signal requesting the contents specified by the determiner 25 at time T124 (REQUEST_CONTENTS 310). In response to the request from the user terminal 3, the content server 7 provides the contents to the user terminal 3 at time T126 (DELIVER_CONTENTS 312) so that the user terminal 3 receives the contents provided from the content server 7 by the network interface 23, and the originator 3 waits for the terminator 5 to take a call while playing the contents in the player 27.

As shown by a dashed line in FIG. 15, the content server 7 may provide the same contents to the user terminal 5 at substantially the same timing as the timing at which the contents are sent to the user terminal 3 (DELIVER_THE_SAME_CONTENTS 314), or may inform the user terminal 5 that contents have been provided, at time T128 (NITIFICATION 316). When contents are sent from the content server 7, the user terminal 5 may receive the contents to make the player play, and, before establishing the communication with the user terminal 3, transmit to the content server 7 a signal requesting the cutoff of the connection with the content server 7 at time T130 (REQUEST_CUTOFF 318), for example.

Thereafter, at time T132 the user terminal 5 sends to the user terminal 3 a signal indicating that the terminator responds to a call, thereby establishing a call with the user terminal 3 (OK_SIGNAL 320). When a call is established, at time T134 the user terminal 3 transmits a signal requesting the cutoff of the connection with the content server 7 so that the player 27 stops playing the contents (REQUES_CUTOFF 322). AS stated above, in the alternative embodiment, contents are provided to the user terminal 3 after performing validation and authentication of subscribers, so it is possible to prevent the user terminal 3 from acquiring contents illegally from the content server 7.

Of course, the procedure shown in FIG. 15 is only illustrative and may be changed or modified, as desired. For example, even if in the PSTN network 103, or even if in a network including both the IP network 9 and the PSTN network 103, the same processing can be carried out. In the PSTN network 103, it is possible to perform the process of authenticating the user terminal 5 between the telephone switch and the content server 7, and it is also possible to perform the process of authenticating the user terminal 5 between the communication server 109 and the content server 7 in the network including both IP network 9 and PSTN network 103.

The entire disclosure of Japanese patent application No. 2006-005973 filed on Jan. 13, 2006, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A method for providing a terminal of a call originator who makes a call to a call terminator with a ringing tone or contents as ringback information informing the originator that the terminator is being called up until communication is established, said method comprising the steps of:
determining whether or not the contents to be provided to the terminal in order to specify either contents or ringing tone; and
providing the specified ringing tone or contents to the terminal of the originator.

2. The method in accordance with claim 1, wherein said determining step is performed based on functions of the terminal of the originator.

3. The method in accordance with claim 1, wherein said determining step performed based on intentions of the originator.

4. The method in accordance with claim 1, wherein said determining step specifies all or part of the specified contents.

5. The method in accordance with claim 1, further comprising an authenticating step of authenticating the terminator.

6. A system for providing ringback information comprising:
a first terminal on a side of an originator who makes a call;
a second terminal on a side of a terminator who receives the call;
a network to which first and second terminals are connected;
a ringing tone generator for producing a ringing tone to be provided to said first terminal in order to inform the originator that the terminator is being called up until communication is established; and
a content server, connected to said network, for storing contents to be provided to said first terminal instead of the ringing tone,
said second terminal comprising a storage for storing information indicating the contents to be provided to said first terminal, and a transmitter for transmitting the information to said first terminal,
said first terminal comprising a determination circuit for determining whether or not the contents are provided to the first terminal itself based on the information in order to specify either contents or a ringing tone,
the specified ringing tone or contents being provided from said ringing tone generator or said content server to said first terminal as the ringback information.

7. The system in accordance with claim 6, wherein said network is an Internet Protocol (IP) network or public switched telephone network (PSTN).

8. A system for providing ringback information comprising:
a first terminal on a side of an originator who makes a call;
a second terminal on a side of a terminator who receives the call;
a mediate device for mediating communication between said first terminal and said second terminal;
a network to which said first and second terminals and said mediate device are connected;
a ringing tone generator for producing a ringing tone which is provided to said originating terminal in order to inform the originator that the terminator is being called up until communication is established; and
a content server, connected to said network, for storing contents to be provided to said first terminal instead of the ringing tone,
said mediate device comprising a storage for storing information indicating the contents to be provided to said first terminal, and a transmitter for transmitting the information to said first terminal;
said first terminal comprising a determination circuit for determining whether or not the contents are provided to the first terminal itself based on the information in order to specify either contents or a ringing tone,
the specified ringing tone or contents being provided from said ringing tone generator or said content server to said first terminal as the ringback information.

9. The system in accordance with claim 8, wherein said network is an Internet Protocol (IP) network and said mediate device is a communication server.

10. The system in accordance with claim 8, wherein said network is a public switched telephone network (PSTN) and said mediate device is a telephone switch.

11. A system for providing ringback information comprising:
a first terminal on a side of an originator who makes a call;
a second terminal on a side of a terminator who receives the call;
a mediate device for mediating communication between said first terminal and said second terminal;
a network to which said first and second terminals and said mediate device are connected;
a ringing tone generator for producing a ringing tone which is provided to said originating terminal in order to inform the originator that the terminator is being called up, until communication is established; and
a content server, connected to said network, for storing contents to be provided to said first terminal instead of the ringing tone,
said second terminal comprising a storage for storing information indicating the contents to be provided to said first terminal and a transmitter for transmitting the information to said first terminal,
said mediate device comprising a determination circuit for determining whether or not the contents are provided to the first terminal based on the information in order to specify either contents or a ringing tone,
the specified ringing tone or contents being provided from said ringing tone generator or said content server to said first terminal as the ringback information.

12. The system in accordance with claim 11, wherein said network is an Internet Protocol (IP) network and said mediate device is a communication server.

13. The system in accordance with claim 11, wherein said network is a public switched telephone network (PSTN) and said mediate device is a telephone switch.

14. A system for providing ringback information comprising:
a first terminal on a side of an originator who makes a call;
a second terminal on a side of a terminator who receives the call;
a mediate device for mediating communication between said first terminal and said second terminal;
a network to which said first and second terminals and said mediate device are connected;
a ringing tone generator for producing a ringing tone which is provided to said originating terminal in order to inform the originator that the terminator is being called up, until communication is established; and
a content server, connected to said network, for storing contents to be provided to said first terminal instead of the ringing tone,
said mediate device comprising a storage for storing information indicating the contents to be provided to said first terminal, a transmitter for transmitting the information to said first terminal, and a determination circuit for determining whether or not the contents are provided to the first terminal based on the information in order to specify either contents or a ringing tone,
the specified ringing tone or contents being provided from said ringing tone generator or said content server to said first terminal as the ringback information.

15. The system in accordance with claim 14, wherein said network is an Internet Protocol (IP) network and said mediate device is a communication server.

16. The system in accordance with claim 14, wherein said network is a public switched telephone network (PSTN) and said mediate device is a telephone switch.

17. A system for providing ringback information comprising:
a first terminal on a side of an originator who makes a call;
a second terminal on a side of a terminator who receives the call;
a first network to which said first terminal is connected;
a second network to which said second terminal is connected;
a mediate device, connected to said first network and second network, for establishing communication between said first terminal and said second terminal;
a converter, connected to said first network and second network, for converting a signal in a first form used in said first network to a signal in a second form used in said second network, and converting a signal in the second form to a signal in the first form;
a ringing tone generator for producing a ringing tone which is provided to said originating terminal in order to inform the originator that the terminator is being called up, until communication is established; and
a content server for storing contents to be provided to said first terminal instead of the ringing tone,
said mediate device comprising a storage for storing information indicating the contents to be provided to said first terminal, and a transmitter for transmitting the information to said first terminal;
said first terminal comprising a determination circuit for determining whether or not the contents are provided to the first terminal itself based on the information in order to specify either contents or a ringing tone,
the specified ringing tone or contents being provided from said ringing tone generator or said content server to said first terminal as the ringback information.

18. The system in accordance with claim 17, wherein said first network is either a public switched telephone network (PSTN) or an Internet Protocol (IP) network, and said second network is an IP network when said first network is the public switched telephone network, or a public switched telephone network when said first network is the IP network.

19. A system for providing ringback information comprising:
a first terminal on a side of an originator who makes a call;
a second terminal on a side of a terminator who receives the call;
a first network to which said first terminal is connected;
a second network to which said second terminal is connected;
a mediate device, connected to said first network and second network, for establishing communication between said first terminal and said second terminal;
a converter, connected to said first network and second network, for converting a signal in a first form used in said first network to a signal in a second form used in said second network, and converting a signal in the second form to a signal in the first form;
a ringing tone generator for producing a ringing tone which is provided to said originating terminal in order to inform the originator that the terminator is being called up, until communication is established; and
a content server for storing contents to be provided to said first terminal instead of the ringing tone,
said second comprising a storage for storing information indicating the contents to be provided to said first terminal, and a transmitter for transmitting the information to said first terminal,
said mediate device comprising a determination circuit for determining whether or not the contents are provided to the first terminal based on the information in order to specify either contents or a ringing tone,
the specified ringing tone or contents being provided from said ringing tone generator or said content server to said first terminal as the ringback information.

20. The system in accordance with claim 19, wherein said first network is either a public switched telephone network (PSTN) or an Internet Protocol (IP) network, and said second network is an IP network when said first network is the public switched telephone network, or a public switched telephone network when said first network is the IP network.

21. A system for providing ringback information comprising:
a first terminal on a side of an originator who makes a call;
a second terminal on a side of a terminator who receives the call;
a first network to which said first terminal is connected;
a second network to which said second terminal is connected;
a mediate device, connected to said first network and second network, for establishing communication between said first terminal and said second terminal;
a converter, connected to said first network and second network, for converting a signal in a first form used in said first network to a signal in a second form used in said second network, and converting a signal in the second form to a signal in the first form;
a ringing tone generator for producing a ringing tone which is provided to said originating terminal in order to inform the originator that the terminator is being called up, until communication is established; and
a content server for storing contents to be provided to said first terminal instead of the ringing tone,
said mediate device comprising a storage for storing information indicating the contents to be provided to said first terminal, a transmitter for transmitting the information to said first terminal, and a determination circuit for determining whether or not the contents are provided to the first terminal based on the information in order to specify either contents or a ringing tone,
the specified ringing tone or contents being provided from said ringing tone generator or said content server to said first terminal as the ringback information.

22. The system in accordance with claim 21, wherein said first network is either a public switched telephone network (PSTN) or an Internet Protocol (IP) network, and said second network is an IP network when said first network is the public switched telephone network, or a public switched telephone network when said first network is the IP network.

23. A terminal for communicating with another terminal over a communication line such as a public switched telephone network (PSTN) or an Internet Protocol (IP) network, said terminal comprising:
a receiver for receiving information transmitted from the other terminal over the communication line, the information indicating contents to be provided to the terminal itself instead of a ringing tone; and
a determination circuit for determining whether or not the contents are provided to the terminal itself based on the information in order to specify either contents or a ringing tone.

24. A terminal for communicating with another terminal over a communication line such as a public switched telephone network (PSTN) or an Internet Protocol (IP) network, said terminal comprising:
a storage for storing information indicating contents to be provided to the other terminal instead of a ringing tone;
an information producer for referencing said storage to produce information on contents; and
a transmitter for transmitting the information to the other terminal.

25. A mediate device for mediating communication between a terminal on a side of a call originator and a terminal on a side of a call terminator over a communication line such as a public switched telephone network (PSTN) or an Internet Protocol (IP) network, said mediate device comprising:
a receiver for receiving information, transmitted over said communication line, the information indicating contents to be provided to the originating terminal; and
a determination circuit for determining whether or not the contents are provided to the originating terminal based on the information in order to specify either contents or a ringing tone.

26. A mediate device for mediating communication between a terminal on a side of a call originator and a terminal on a side of a call terminator over a communication line such as a public switched telephone network (PSTN) or an Internet Protocol (IP) network, said mediate device comprising:
a storage for storing information indicating contents to be provided to the originating terminal instead of a ringing tone; and
a transmitter for transmitting the information to the originating terminal.

27. A mediate device for mediating communication between a terminal on a side of a call originator and a terminal on a side of a call terminator over a communication line such as a public switched telephone network (PSTN) or an Internet Protocol (IP) network, said mediate device comprising:
a storage for storing information indicating contents to be provided to the originating terminal instead of a ringing tone; and
a determination circuit for determining whether or not the contents are provided to the originating terminal based on the information in order to specify either contents or a ringing tone.
